(19) United States
(12) Patent Application Publication
(10) Pub. No.: US 2016/0059908 A1
(43) Pub. Date: Mar. 3, 2016

(54) MOUNTING SYSTEM FOR CAB

(71) Applicant: Caterpillar Inc., Peoria, IL (US)

(72) Inventor: Keegan W. Roach, Peoria, IL (US)

(73) Assignee: Caterpillar Inc., Peoria, IL (US)

(21) Appl. No.: 14/468,988

(22) Filed: Aug. 26, 2014

(51) Int. Cl. B62D 33/067

(52) U.S. Cl. CPC B62D 33/067

(57) ABSTRACT

A cab frame mounting system including a cab mount configured to be mounted to a cab of a machine, and comprising a first ball and socket device. The cab frame mounting system can also include a frame mount configured to be mounted to a frame of the machine, and comprising a second ball and socket device different than the first ball and socket device. The first ball and socket device and the second ball and socket device are configured to cooperate with each other to secure the cab to the frame while allowing rotational movement of the cab relative to the frame.

### TECHNICAL FIELD

The present disclosure relates generally to a mounting system, and more particularly, to the mounting system for mounting a cab on a machine.

### BACKGROUND

Construction machines, such as trucks, include an operator cab. The cab may have an operator interface therein to allow an operator seated within the cab to maneuver the machine and/or perform an operation using a work implement of the machine.

During maintenance, the cab may need to be removed or tilted in order to access components present below the cab. Accordingly, in some machines, the cabs are pivotally mounted to a frame of the machine, via a mount structure. However, the design of the mount structure is such that during machine operation, the cab may experience fore and aft movements about the pivot connection to the frame of the machine. Additional movements, such as side to side or up and down movements may also be experienced. This may affect an overall experience of the operator, impacting the operator ride and perception.

U.S. Patent Publication No. 2002/0104699 to Damhuis (hereinafter the '699 patent) discloses a support comprising a locking hook and a permanent blocking mechanism, for example, a retaining pin, is fitted on the underside of the cab. The top end of the piston rod is provided with a projection and is positioned in such a way that said projection can be brought into engagement with the locking hook.

The fitting of the piston rod on the cab then takes place automatically when the cab is moved in the direction of the chassis, by the fact that the projection and the locking hook engage with each other and the retaining pin subsequently fixes the locking hook in a specific position relative to the support, as a result of which a permanent coupling between the top end of the piston rod and the cab is produced. However the cab in the '699 patent may still experience fore and aft movements or other movements such as side to side or up and down movements.

The system and method of the present disclosure solves one or more problems set forth above and/or other problems in the art.

### SUMMARY

In one aspect, the present disclosure is directed to a cab frame mounting system including a cab mount configured to be mounted to a cab of a machine, and comprising a first ball and socket device. The cab frame mounting system can also include a frame mount configured to be mounted to a frame of the machine, and comprising a second ball and socket device different than the first ball and socket device. The first ball and socket device and the second ball and socket device are configured to cooperate with each other to secure the cab to the frame while allowing rotational movement of the cab relative to the frame.

In another aspect, the present disclosure is directed to a cab frame mounting system including a frame mount configured to be mounted to a frame of a machine, and comprising a ball. The cab frame mounting system can also include a cab mount configured to be mounted to a cab of the machine, and comprising a first socket defining element and a second socket defining element. The first socket defining element and the second socket defining element are configured to be secured to each other to form a socket. The ball and the socket are configured to cooperate with each other as a ball and socket joint to secure the cab to the frame while allowing rotational movement of the cab relative to the frame.

In another aspect, the present disclosure is directed to a machine including a frame, a cab, and a cab frame mounting system coupled between the cab and the frame. The cab frame mounting system can include a cab mount coupled to the cab, and comprising a first ball and socket device. The cab frame mounting system can also include a frame mount coupled to the frame, and comprising a second ball and socket device different than the first ball and socket device.

### BRIEF DESCRIPTION OF THE DRAWINGS

FIG. 1 depicts a machine according to an embodiment;

FIG. 2 depicts a cab, a frame, and a cab frame mounting system according to an embodiment;

FIG. 3 is partial view of a cab, a frame, a cab mount, and a frame mount according to an embodiment;

FIG. 4 is a partial view of a cab mount according to an embodiment;

FIG. 5 is a top view of socket defining elements according to an embodiment; and

FIG. 6 is a partial view of a cab, a frame, a cab mount, and a frame mount according to an embodiment.

### DETAILED DESCRIPTION

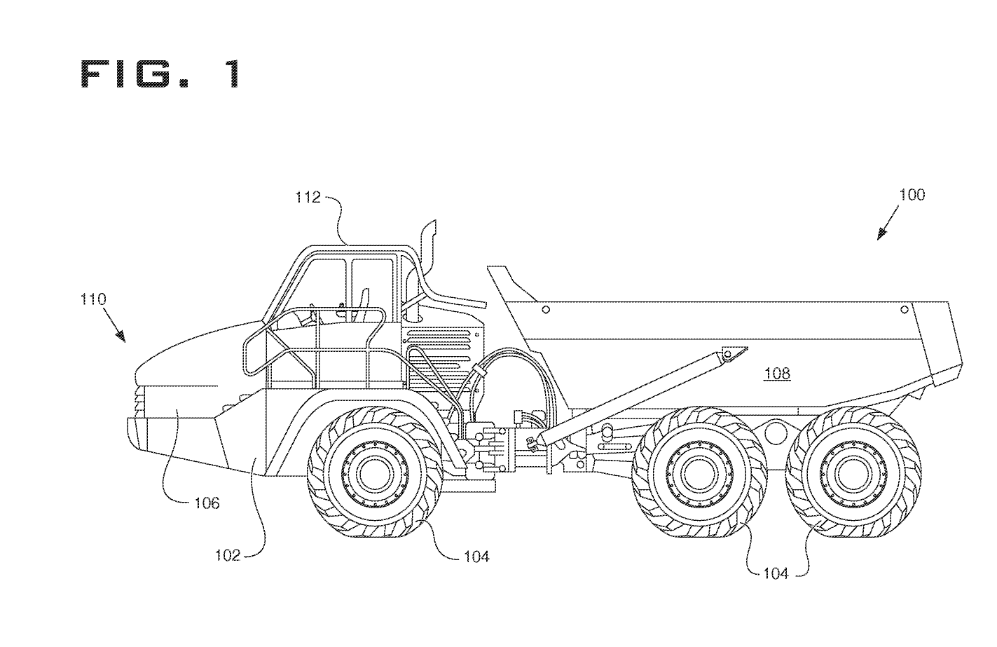

FIG. 1 depicts an exemplary machine 100. In an embodiment, the machine 100 may comprise an articulated truck. Alternatively, the machine 100 may include a track-type tractor, a hydraulic excavator, a wheel loader, a haul truck, a large mining truck, an off-highway truck, and the like. It should be understood that the machine 100 may comprise any wheeled or tracked machine associated with mining, agriculture, forestry, construction, and other industrial applications.

As illustrated in FIG. 1, the exemplary machine 100 includes at least one or more of the following: a frame 102, ground engaging elements 104, an engine compartment 106, and a payload carrier 108. The machine 100 may further include an engine positioned in the engine compartment 106 and supported on the frame 102. The engine may be an internal combustion engine such as, for example, a reciprocating piston engine or a gas turbine engine. In an embodiment, the engine includes a spark ignition engine or a compression ignition engine such as, a diesel engine, a homogeneous charge compression ignition engine, or a reactivity controlled compression ignition engine, or other compression ignition engine known in the art. The engine may be fueled by gasoline, diesel, biodiesel, dimethyl ether, alcohol, natural gas, propane, hydrogen, combinations thereof, or any other combustion fuel known in the art.

In the illustrated embodiment, a cab 112 is mounted on a front end 110 of the frame 102 of the machine 100. The cab 112 may be disposed above the engine and extends rearward beyond the engine. In some embodiments, the cab 112 may enclose the engine by forming a portion of the engine compartment 106. The cab 112 may include a suitable station for a machine operator, and may house various controls, displays, and interface equipment for machine operation. In addition, the cab 112 may be structured in such a way as to provide roll-over protection for the machine operator, and also to mitigate potential damage to the machine operator in the event of roll-over.

In an embodiment, the cab 112 may be tilted, which will be described in more detail later. Tilting the cab 112 can provide access to components of the machine 100 underneath, adjacent, or enclosed by the cab 112. The access can be, for example, maintenance of the components. As previously described, the components can include the engine. However, in an embodiment the components can include a transmission, a hydraulic system, a drive system, or any other component that may be covered by the cab 112.

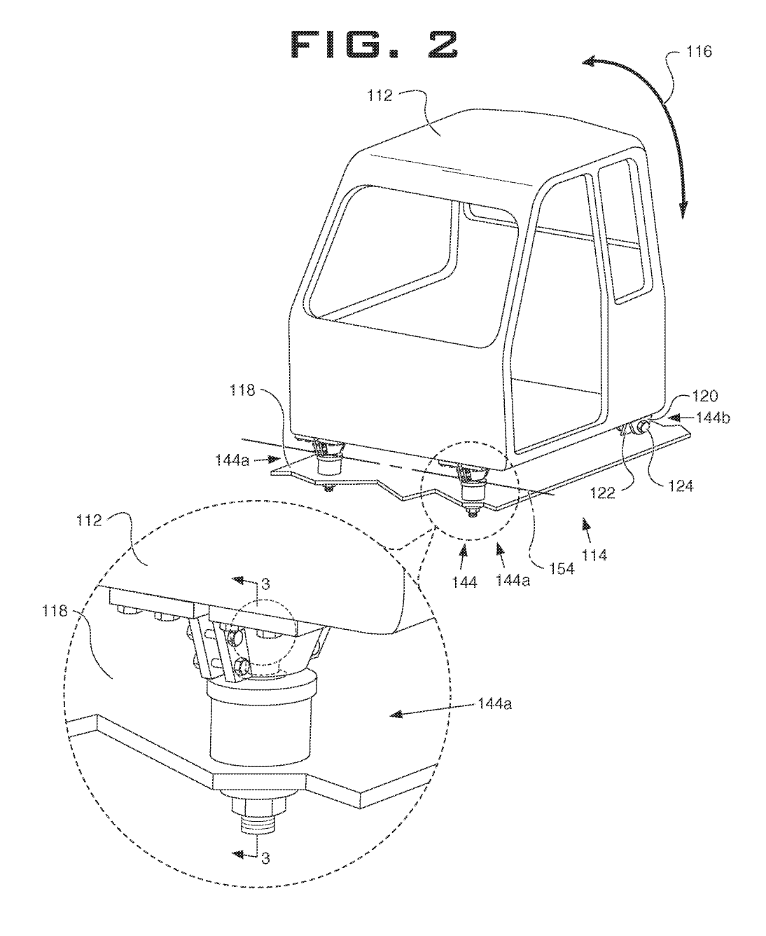

As seen in FIG. 2, the cab 112 comprises a cab frame mounting system 114 to mount the cab 112 to a frame 118. The cab frame mounting system 114 can include one or more mounts 144, such as a mount 144a and a mount 144b. In the embodiment shown in FIG. 2, the cab frame mounting system 114 comprises two mounts 144a and two mounts 144b. In an embodiment, manipulation of the two mounts 144b can permit rotational movement of the cab 112 relative to a frame 118 along a pivot axis defined between the two mounts 144a. The rotational movement can be seen, for example, in arrow 116

Although the rotational movement of the cab 112 is in the direction indicated by the arrow 116, the direction can vary based on the location of the mounts 144a, 144b, or any combination thereof, which will be described in more detail below. Furthermore, rotational movement of the cab can comprise tilting the cab 112.

For example, each of the mount 144b comprises a cab mount 120 and a frame mount 122. The cab mount 120 can include two substantially parallel plates, while the frame mount 122 can include a single parallel plate, or vice versa. A bolt 124 can be inserted through aligning bores formed into the cab mount 120 and the frame mount 122 to secure the cab mount 120 to the frame mount 122 and the cab 112 to the frame 118. Once the bolt 124 is removed, the cab mount 120 is released from the frame mount 122, and rotational movement of the cab 112 relative to a frame 118 along a pivot axis 154 defined between the two mounts 144a is permitted.

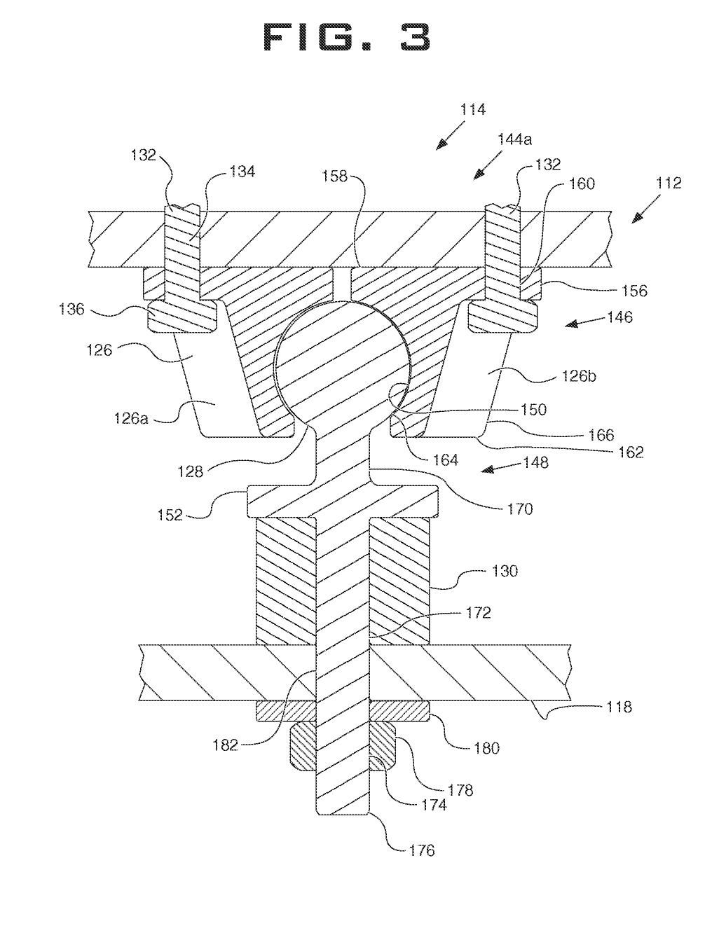

In FIG. 3, the mount 144a is shown in greater detail. As can be seen in FIG. 3, the mount 144a can include a cab mount 146 and a frame mount 148 configured to cooperatively permit relative movement between the cab and the frame. The cab mount 146 and the frame mount 148 can each comprise a ball and socket device. For example, in FIG. 3, the cab mount 146 includes socket defining elements 126 such as socket defining element 126a and socket defining element 126b. The socket defining elements 126a and 126b are configured to be secured to each other to form a socket 150.

In an embodiment, each of the socket defining elements 126a and 126b can include a base portion 156 and an end portion 162 located opposite the base portion 156. The base portion 156 can include a planar surface 158 configured to contact the cab 112. In an embodiment, each of the socket defining elements 126a and 126b can also include an inner surface 164, and an outer surface 166 spaced apart from the inner surface 164. The inner surface 164 can aid in defining or partially defining the socket 150. In an embodiment, the outer surface 166 can be configured to be tapered from the base portion 156 to the end portion 162. However, in an embodiment, the outer surface 166 can have alternate configurations aside from being tapered. In addition, the socket defining elements 126a and 126b can rectangular, circular, or semi-circular.

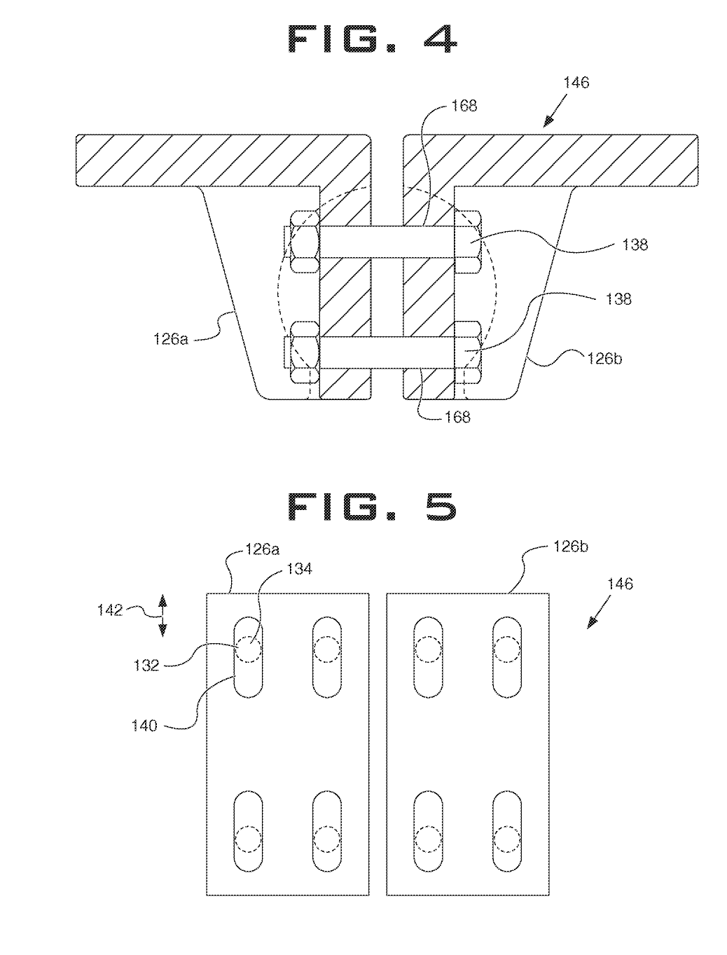

The socket defining elements 126a and 126b can be coupled to one another in a secure fashion. For example, in FIG. 4, the socket defining elements 126a and 126b can be releasably secured to each other using fasteners 138. The fasteners 138 can include nuts, bolts, screws, or other devices which can extend laterally to secure to downwardly depending body portions of the socket defining elements 126a and 126b to each other. The fasteners 138 can extend through bores 168 located on the socket defining elements 126a and 126b. However, in an embodiment, the socket defining elements 126a and 126b can also be secured to each other using welding, adhesives, or other means which can sufficiently secure the socket defining elements 126a and 126b to each other. In an embodiment, the socket defining elements 126a and 126b form a unitary element.

Referring back to FIG. 3, the frame mount 148 includes a ball 128. The socket defining elements 126a and 126b are configured to secure the ball 128. In an embodiment, the ball 128 can be configured to rotate within the socket 150 as a ball and socket joint. In FIG. 3, the socket defining elements 126a and 126b and the ball 128 comprise ball and socket devices. Furthermore, although only two socket-defining elements 126a and 126b are shown, more or less socket defining elements 126 may be utilized. In addition, to aid in rotation of the ball 128 within the socket 150, lubricant can be located between the ball 128 and the socket 150. Alternately, to aid in rotation of the ball 128, a liner composed of a low friction material such as polytetrafluoroethylene may be inserted between the ball 128 and the socket 150. In an embodiment, the polytetrafluoroethylene may comprise Teflon® manufactured by Dupont Co. The liner can be a permanent or semi-permanent liner. In addition, a coating of low friction material may be plated, laminated, glued, or otherwise applied to either one or both of the ball 128 and the socket 150. The coating may be a permanent or semi-permanent coating.

In an embodiment, the frame mount 148 can include a platform 152 disposed underneath the ball 128. Furthermore, the frame mount 148 can include a neck 170 located between the ball 128 and the platform 152, and a body 172 extending from the platform 152 through a bore 182 in the frame 118. The body 172 can also include a tip section 176 located opposite the ball 128. The tip section 176 can include a threaded section 174 to allow the frame mount 148 to be secured to the frame 118 using a nut 178 and a washer 180.

As shown in FIG. 3, the cab frame mounting system 114 can also include an isolation mount 130 located between the ball 128 and the frame 118. In an embodiment, the isolation mount 130 can be located between the frame mount 148 and the frame 118. The isolation mount 130 can be captured between a lower surface of the platform 152 and an upper surface of the frame 118. In an embodiment, the isolation mount 130 can include a shock absorber, such as a rubber mount, a viscous mount, a magneto-rheological (“MR”) semi-active mount, or any combination thereof. The shock absorber can reduce vibrations and improve a comfort of an operator in the cab 112.

In an embodiment, the isolation mount 130 can also include steel or metal. In yet another embodiment, the isolation mount 130 is optional. Instead, there can be a direct bolt or weld connection between the frame mount 148 and the frame 118. For example, the platform 152 can directly contact or be directly connected to the frame 118. Thus, the platform 152 can be welded to the frame 118, or one or more bolts can be utilized to connect the platform 152 to the frame 118. In an embodiment, there can also be an adhesive connection between the frame mount 148 and the frame 118. In such a case, the platform 152 can be adhered to the frame 118 using an adhesive, such as epoxy.

The cab mount 146 can be coupled to the cab 112 in a secure fashion. For example, as shown in FIG. 3, the cab mount 146 can be releasably coupled to the cab 112 using fasteners 132. The fasteners 132 can include an elongated section 134 extending from a head section 136. The fasteners 132 can be fitted through a bore 160 located in the base portion 156.

FIG. 5 depicts an overhead view of the cab mount 146. As can be seen, each of the socket defining elements 126a and 126b includes one or more channels 140 formed therein. The channels 140 are configured to allow the cab mount with the fasteners 132 to be adjusted relative to the cab to move in multiple directions, represented by arrows 142. In an embodiment, the directions represented by the arrows 142 is substantially perpendicular to the elongated section 134. This can, for example, allow the cab mount 146 to have a better fit when mounted to the cab 112 due to misalignment of holes and tolerances for creation of holes during manufacturing. Furthermore, although the directions indicated by the arrows 142 are shown in FIG. 5, the channels 140 can also allow movement in other directions instead of or in addition to the directions indicated by the arrows 142. In an embodiment, such an arrangement may also be reversed with the socket defining elements 126a and 126b can comprise the channels 140, while the cab 112 comprises the bore 160. Depending on the arrangement, as described in more detail below, the frame 118 may comprise the bore 160 instead of the cab 112.

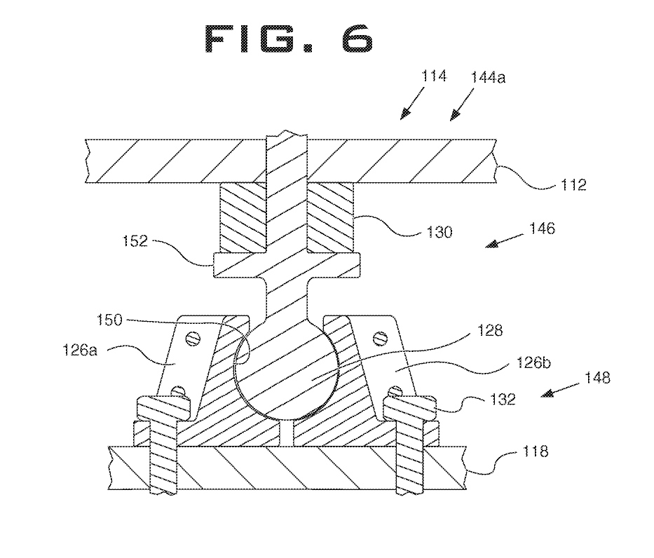

As previously noted, the cab mount 146 and the frame mount 148 can each comprise a ball and socket device. Thus, the type of each of the ball and socket devices can be reversed. For example, as shown in FIG. 6, where like reference numerals of FIGS. 1-5 are used, the cab mount 146 can comprise the ball 128 and the platform 152 while the frame mount 148 can comprise the socket defining elements 126.

Referring to FIG. 2, the number, location, and type of the mounts 144 may be changed. For example, the mounts 144a may be utilized towards a first side of the cab 112, and the mounts 144b can be utilized towards a second side of the cab opposite the first side of the cab 112. The first side of the cab 112 can be a location of a desired pivot axis for rotational movement of the cab 112. In an embodiment, only the mounts 144a are utilized when no rotational movement of the cab 112 about a pivot axis is desired.

### INDUSTRIAL APPLICABILITY

The use of the mounts 144a can allow better rotational movement of the cab 112. For example, the formation of the pivot axis 154 utilizing two ball and socket joints can increase surface contact between the cab mount 146 and the frame mount 148, which can reduce an amount of gap between the cab mount 146 and the frame mount 148. That is, the ball 128 and the socket 150 can have a larger surface contact between each other relative to other connection devices, such as the plates and bolts utilized in the mount 144b. The surface contact need not be direct surface-to-surface contact as lubricant may be located between the surface of the ball 128 and the surface of the socket 150. The result is that during movement of the machine 100, the cab 112 may be less prone to fore and aft movements about the mounts 144a. The cab 112 may also be less prone to side to side or up and down movements about the mounts 144a. This can improve an overall experience of the operator of the machine 100. The isolation mount 130 can also reduce vibrations felt by the operator in the cab 112.

Furthermore, the ball and socket joints formed by the mounts 144a can allow rotational movement of the cab 112 for accessing components of the machine 100. This can maintain serviceability of the machine 100 and in some instances reduce a size of the machine 100.

It will be apparent to those skilled in the art that various modifications and variations can be made to the disclosed system and method. Other embodiments will be apparent to those skilled in the art from consideration of the specification and practice of the disclosed system and method. It is intended that the specification and examples be considered as exemplary only, with a true scope being indicated by the following claims.

What is claimed is:

1. A cab frame mounting system comprising:
a cab mount configured to be mounted to a cab of a machine, and comprising a first ball and socket device; and
a frame mount configured to be mounted to a frame of the machine, and comprising a second ball and socket device different than the first ball and socket device,
wherein the first ball and socket device and the second ball and socket device are configured to cooperate with each other to secure the cab to the frame while allowing rotational movement of the cab relative to the frame.

2. The cab frame mounting system of claim 1 wherein the first ball and socket device comprises at least one of a ball or a socket, and the second ball and socket device comprises at least one of a ball or a socket.

3. The cab frame mounting system of claim 1 wherein the first ball and socket device comprises a ball, and the second ball and socket device comprises a plurality of socket defining elements.

4. The cab frame mounting system of claim 3 wherein the plurality of socket defining elements are configured to be secured to each other to secure the ball.

5. The cab frame mounting system of claim 4 further comprising a shock absorber located between the ball and the frame.

6. The cab frame mounting system of claim 5 further comprising a plurality of fasteners to secure the plurality of socket defining elements to each other.

7. The cab frame mounting system of claim 3 further comprising a plurality of fasteners having an elongated section to secure the plurality of socket defining elements to the frame, and wherein at least one of the plurality of socket defining elements defines a channel to allow movement of at least one of the plurality of fasteners in a direction substantially perpendicular to the elongated section.

8. The cab frame mounting system of claim 1 further comprising lubricant located between the first ball and socket device and the second ball and socket device.

9. A cab frame mounting system comprising:
a frame mount configured to be mounted to a frame of a machine, and comprising a ball; and
a cab mount configured to be mounted to a cab of the machine, and comprising a first socket defining element and a second socket defining element,
wherein the first socket defining element and the second socket defining element are configured to be secured to each other to form a socket, and
wherein the ball and the socket are configured to cooperate with each other as a ball and socket joint to secure the cab to the frame while allowing rotational movement of the cab relative to the frame.

10. The cab frame mounting system of claim 9 further comprising a plurality of fasteners to secure the first socket defining element and the second socket defining element to each other.

11. The cab frame mounting system of claim 9 further comprising a plurality of fasteners having an elongated section to secure the first socket defining element and the second socket defining element to the frame, and wherein each of the first socket defining element and the second socket defining element defines a channel to allow movement of at least one of the plurality of fasteners in a direction substantially perpendicular to the elongated section.

12. The cab frame mounting system of claim 9 further comprising lubricant located between the ball and the socket.

13. A machine comprising:
a frame;
a cab; and
a cab frame mounting system coupled between the cab and the frame, comprising:
a cab mount coupled to the cab, and comprising a first ball and socket device; and
a frame mount coupled to the frame, and comprising a second ball and socket device different than the first ball and socket device,
wherein the first ball and socket device and the second ball and socket device are configured to cooperate with each other to secure the cab to the frame while allowing rotational movement of the cab relative to the frame.

14. The machine of claim 13 wherein the first ball and socket device comprises one of a ball or a socket, and the second ball and socket device comprises the other of a ball or a socket.

15. The machine of claim 13 wherein the cab mount is a first cab mount and the frame mount is a first frame mount, wherein the cab frame mounting system further includes a first mount and a second mount each including the first cab mount and the first frame mount, and a third mount and a fourth mount each including a second cab mount and a second frame mount configured to be decoupled from one another to permit the rotational movement of the cab relative to the frame along a pivot axis defined between the first mount and the second mount.

16. The machine of claim 13 wherein the first ball and socket device comprises a ball, and the second ball and socket device comprises a plurality of socket defining elements, wherein the plurality of socket defining elements are configured to be secured to each other to secure the ball.

17. The machine of claim 16 wherein the plurality of socket defining elements are configured to be secured to each other to form a socket to secure the ball.

18. The machine of claim 17 further comprising a plurality of fasteners configured to secure the plurality of socket defining elements to each other.

19. The machine of claim 16 further comprising a plurality of fasteners comprising an elongated section configured to secure the plurality of socket defining elements to the frame, and wherein at least one of the plurality of socket defining elements defines a channel to allow movement of at least one of the fasteners in a direction substantially perpendicular to the elongated section.

20. The machine of claim 13 further comprising an engine, wherein the rotational movement of the cab relative to the frame allows or prevents access to portions of the engine.
